(19) United States
(12) Patent Application Publication
(10) Pub. No.: US 2011/0250357 A1
(43) Pub. Date: Oct. 13, 2011

(54) Vacuum Coating System and Method for Operating a Vacuum Coating System

(76) Inventor: Guido Willers, Halie (DE)

(21) Appl. No.: 13/139,860

(22) PCT Filed: Dec. 9, 2009
(86) PCT No.: PCT/DE09/01729

§ 371 Date: Jun. 15, 2011

(30) Foreign Application Priority Data
Jan. 9, 2009 (DE) 10 2009 004 493.0

(51) Int. Cl. B05D 7/00; B05C 13/02; B05D 1/00; B05C 11/00

(52) U.S. Cl. 427/294; 118/50

(57) ABSTRACT

The present invention relates to a vacuum coating system (01), comprising at least one process chamber (02) that can be evacuated, at least one entry opening (10) and at least one exit opening (11), wherein wafer elements (03), which are coated in the process chamber (02) while passing through, can be fed into and removed from the process chamber through the entry opening (10) and the exit opening (11), and wherein a paddle valve (08, 09), which can be adjusted between an open position and a pressure-tight closed position along a paddle valve closing path, is respectively provided on the entry opening (10) and on the exit opening (11), and wherein for the purpose of transporting the wafer elements (03) a transport system having at least three transport devices (04, 05, 06, 07) is provided, wherein the first transport device (04, 17) is arranged upstream of the entry opening (10), the second transport device (05, 17) is arranged in the process chamber (02) and the third transport device (06, 17) is arranged downstream of the exit opening (11), and wherein each transport device (04, 05, 06, 17) comprises at least one revolving transport element (14, 18) on which the wafer elements (03) can be placed from above and can be delivered through the vacuum coating system (01) by revolvingly driving the transport elements (14, 18) in the transport direction (07), wherein the transport system has an adjustable transfer transport device (12, 13, 16) at the entry opening (10) and/or at the exit opening (11), said transfer transport device being adjustable between a transfer position and an idle position, wherein in the transfer position of the transfer transport device (12, 13, 16) the wafer elements (03) can be transferred from one transport device (04, 05, 06, 17) to the next transport device downstream in the delivery direction (7) through the open entry opening or through the open exit opening, wherein in the idle position of the transfer transport device (12, 13, 16) the entry opening (10) and/or the exit opening (11) can be opened or closed by adjusting the associated paddle valve (08, 09) along the paddle valve closing path.

The present invention relates to a vacuum coating system for coating wafer elements according to the preamble of claim 1. Moreover, the present invention relates to a method for coating wafer elements in a vacuum coating system.

Generic vacuum coating systems for instance are used for producing the solar cells which are required for the manufacture of solar modules. During the production process of the solar cells, the wafer elements required for this purpose are coated in the vacuum coating system with at least one thin film. Vacuum coating systems of this nature are specified for instance in documents EP 1 870 487 A1 and EP 1 956 111 A1.

In order to be able to perform the coating process in the process chamber of the vacuum coating system, the process chamber needs to be largely evacuated. For the purpose of maintaining the vacuum in the vacuum coating system, it is thus necessary that the substrates to be coated, in the case at hand the wafer elements, are fed into and removed from the vacuum coating system through an entry opening, respectively through an exit opening, wherein the entry opening and the exit opening are each provided with a paddle valve. The paddle valve makes it possible to close the entry opening and the exit opening in a pressure-tight manner so as to ensure that the vacuum within the process chamber is separated from the ambient atmosphere. In the known systems, for the purpose of enhancing efficiency, provision is typically made for an entry lock having the entry opening, a pre-treatment chamber, several process chambers, a post-treatment chamber and an exit lock having the exit opening. The pre-treatment chamber, the various process chambers and the post-treatment chamber in turn can equally be separated from one another by means of paddle valves. Each individual chamber of an entire system, which can each be locked by two paddle valves, is supposed to be understood as a process chamber within the meaning of the present invention.

For the purpose of transporting the substrates to be coated through the vacuum coating system, inline transport systems are known, which enable the substrates the substrates to be coated to pass through the vacuum coating system. In order to enable the passing through at least one process chamber of the vacuum coating system, at least three transport devices which are separated from one another are necessary to this end. Here, the first transport device is arranged upstream of the entry opening, the second transport device is arranged in the actual process chamber and the third transport device is arranged downstream of the exit opening. This division of the transport system into three separate transport devices is necessary, since the process chamber needs to be sealed in a pressure-tight manner by closing the paddle valves. Such a pressure-tight sealing using the paddle valves, however, cannot be realized if a continuous transport device reaches through the entry opening, respectively through the exit opening. As a result, gaps are created between the individual transport devices in the region of the entry opening and the exit opening. During transport of the substrates through the vacuum coating system, the substrates are required to bridge said gaps between the individual transport devices.

The bridging of the gaps between the individual transport devices can be realized without any problems in large substrates, such as functional glass panes. Due to their size, said large substrates are capable of straddling the gap between the transport devices without any problems while passing through. In the coating of relatively small-sized substrates, such as wafer elements, having a size for instance in the range of less than 1,100 cm² and a thickness of less than 0.5 mm, straddling of the gaps between the transport devices which are arranged one behind the other is not possible, since due to their relatively short length, the wafer elements do not permit straddling of the gap, but rather would fall into the gap between the transport devices during transport from one transport device to the downstream transport device. In order to nevertheless enable coating of such small-sized substrates, in particular wafer elements, for the production of solar modules having dimensions of 156 mm×156 mm, so-called carriers are employed. Document DE 102 05 168 A1 for instance describes a vacuum coating system, wherein the substrates are delivered through the vacuum coating system with the aid of carriers. During operation of said vacuum coating systems, in a first step, a certain number of wafer elements are placed onto a carrier, and said carrier is subsequently delivered through the vacuum coating system jointly with the wafer elements. Due to the larger surface of the carrier, straddling of the gaps between the individual transport devices of the vacuum coating system can be realized without any problems. However, the utilization of the carrier involves considerable drawbacks.

Due to the delivery of the wafer elements with the aid of carriers, it is absolutely necessary to place the wafer elements onto the carriers in front of the vacuum coating system and to remove the wafer elements again subsequent to the coating. By loading and unloading the carrier, the necessary process time is extended considerably. Moreover, the necessary loading and unloading systems, for instance the handling robots employed in this process, give rise to high costs, for instance for the required operating spaces and the provision of the necessary handling tools.

The carriers per se, which need to be produced from a specially designed material, for instance a carbon fiber fabric, give rise to considerable investment costs. Said investment costs are increased even more by the aspect that the carriers wear out relatively quickly as a result of the process conditions in the vacuum coating system. Furthermore, the coating results in the vacuum coating systems are adversely affected in the vacuum coating system by the insertion of the carriers into the process chamber, since depending on the service life and the type of pre-treatment of the carriers, the coating process is subjected to undesired fluctuations. In addition, the yield of utilizable wafer elements is reduced by the known vacuum coating systems, since the highly sensitive wafer elements can break very easily during loading and unloading of the carriers. Typically, a loss of 1 percent of the wafer elements delivered through the vacuum coating system can be expected as a result of the loading and unloading of the carriers. Departing from this state of the art, it is thus an object of the present invention to suggest a vacuum coating system which makes it possible to overcome the aforesaid drawbacks. It is another object of the present invention to suggest a method for operating a vacuum coating system which equally avoids said drawbacks.

This object is attained by a vacuum coating system and a method for operating a vacuum coating system according to the teaching of the two independent main claims.

Advantageous embodiments of the invention are the subject-matter of the dependent claims.

The basic concept of the invention relies on the utilization of a transfer transport device by means of which the wafer elements can be transported over the gap between two transport devices which are arranged one behind the other. Here, the transfer transport device can be arranged either upstream of or else downstream of the respective entry opening or exit opening, depending on the direction in which the respective paddle valve opens. A characteristic of the transfer transport device is that it can be adjusted between a transfer position and an idle position. In the transfer position, the wafer elements can be transferred into the delivery direction over the gap between the two transport devices through the open entry opening or else the open exit opening. In order to be able to close the paddle valves again after entry of the wafer elements, the transfer transport device is also configured in such a manner that it can be moved into an idle position. In said idle position, the transfer transport device is arranged outside of the paddle valve closing path such that adjustment of the paddle valve between the open position and the pressure-tight closed position along the paddle valve closing path can be realized in both directions without any problems.

As a result, the gap to be bridged between the transport devices, which are arranged one behind the other, is reduced by the inventive transfer transport device to the extent that direct transfer of the wafer elements is feasible without any problems and without a need for firstly reloading the wafer elements onto a carrier. In order to preclude that the closing of the entry opening and the exit opening is rendered impossible by the transfer transport device, the transfer transport device is adjustably mounted. By moving the transfer transport device from the transfer position into the idle position, opening and closing of the paddle valves is enabled.

The manner in which the closing mechanism of the paddle valves is designed is basically optional. With regard to the production of wafer elements, however, pivotably mounted paddle valves, which in response to a pivoting movement can be adjusted between the open position and the pressure-tight closed position, are particularly advantageous, since due to the susceptibility to breakage of the wafer elements, it cannot generally be ruled out that fragments might get into the closing gap. Pivotably mounted paddle valves, which during their pivoting movement are pressed against the sealing gap, are highly insensitive to fragments in the sealing gap.

Moreover, it is particularly advantageous if provision is made for a sealing member on the side of the paddle valve that faces towards the entry opening and the exit opening, in order to be able to seal the sealing gap between the wall of the process chamber and the paddle valve in the closing position of the paddle valve in a pressure-tight manner. In particular, in this way, the intrusion of external atmosphere into the interior of the process chamber is prevented, respectively rendered more difficult. The type of the transport elements used for transporting the wafer elements in the transport devices and at the transfer transport devices between the individual transport devices is basically optional. With regard to the susceptibility to breakage of the wafer elements, however, it is particularly advantageous if conveyor belts, conveyor cords or else conveyor wires are utilized for delivering the wafer elements. Said revolving conveying members make it possible that the wafer elements placed from above are transferred essentially without the action of external forces between the individual transport devices, respectively the transfer transport devices. In this context, it should only be ensured that the remaining distance between the transport devices and the interposed transfer transport devices is small enough to enable straddling of said gap without any problems due to the length of the wafer elements.

With regard to a substantially undisturbed coating of the wafer elements in the process chamber, it is particularly advantageous if the transport elements are produced from a metallic material or a polymeric material, in particular woven polymer filaments, or a ceramic material, in particular woven ceramic filaments. By means of this measure, sufficient mechanical resistance together with the required temperature stability can be ensured.

For realizing the adjustability of the transfer transport devices required for the invention, various constructional options are available. According to a first embodiment of an adjustable transfer transport device, provision is made for the transport element of a transfer transport device being clamped over two deflecting members, in particular deflection rollers, wherein at least one deflecting member is pivotably mounted. By pivoting the pivotably mounted deflection roller upwardly or downwardly, the deflecting member can be pivoted between the transfer position and the idle position in order to ensure in this way the closing or opening of the paddle valves.

In the simplest embodiments, the transfer transport device is configured as a separate installation which is placed between the transport devices, which are arranged one behind the other.

Alternatively, embodiments are conceivable, wherein the transfer transport device is integrated into the transport devices which are provided at the vacuum coating system anyway. It is a characteristic of said integration of the transfer transport device into the available transport devices that the transfer transport device and the associated transport device use a common transport element, for instance a conveyor belt or a conveyor cord, for transporting the wafer elements. Here, the part of the transport device that forms the transfer transport device within the meaning of the invention is adjustable such that said part can be adjusted between the transfer position and the idle position.

A possible embodiment for integrating the transfer transport device into one of the upstream or downstream transport devices consists in the common transport element being clamped over two deflecting members, wherein at least one of the deflecting members can be adjusted between the transfer position and the idle position.

In order to be able to more easily realize the necessary change of length of the effective length of the transport element during adjustment of the deflecting member, it is conceivable to guide the transport element over a mechanically adjustable clamping member. Depending on the position of the adjustable deflecting member, said clamping member releases the transport element to an additional length, in order to thus ensure the necessary length compensation during adjustment between the transfer position and the idle position.

A main advantage of the inventive vacuum coating system is the aspect that reloading of the wafer elements onto the carriers and downloading of the wafer elements from the carriers is not necessary any more. The omission of the loading and unloading of the carriers and the thus possible omission of the need for buffering the wafer elements at the entry, respectively at the exit of the vacuum coating system makes it possible without any problems to integrate the vacuum coating system into larger installation lines. By arranging further systems for processing the wafer elements upstream and downstream of the vacuum coating system, the wafer elements can then be further transported without any problems from one system to the next system while passing through, wherein intermediate storage between the individual system parts can be omitted. The inventive method for coating wafer elements in a vacuum coating system is characterized by the aspect that for opening and closing of the paddle valves at the entry opening and at the exit opening, the transfer transport device arranged there is respectively transferred into its idle position. For transferring the wafer elements through the entry opening, respectively through the exit opening, the paddle valve in each case is completely opened and the transfer transport device is moved into its transfer position.

According to a preferred method variant, the opening and closing of the paddle valve should be performed by means of pivoting into the open position and into the closed position. For integrating the vacuum coating into larger installation lines, after passing through an upstream system the wafer elements can be transferred to the vacuum coating system directly and without intermediate storage while passing through.

Moreover, it is equally possible to transfer the wafer elements coated in the vacuum coating system and having passed through the vacuum coating system into the downstream plant without intermediate storage and while passing through.

Various aspects of the invention are schematically illustrated in the drawings and will be exemplarily described in the following:

In the drawings:

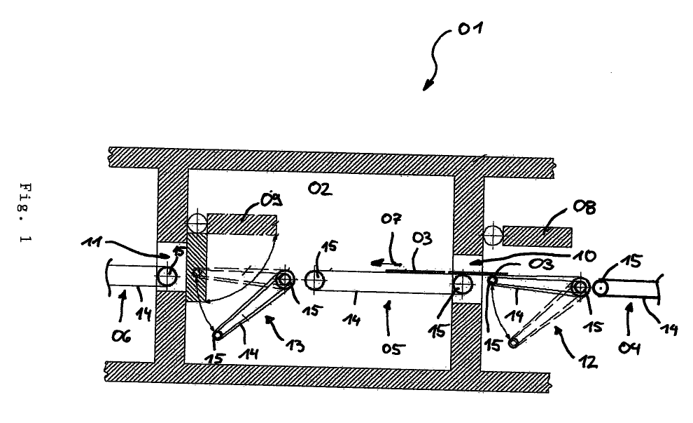

FIG. 1 shows a section of a first variation of a vacuum coating system having transfer transport devices in a cross-sectional view;

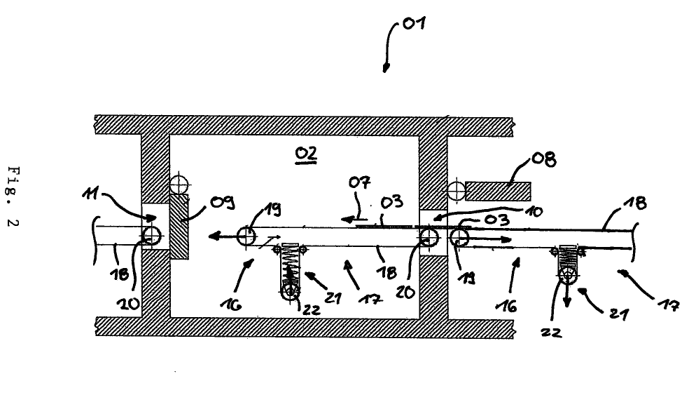

FIG. 2 shows a second variation of a vacuum coating system having the transfer transport devices in a cross-sectional view;

FIG. 1 shows a vacuum coating system 01 in a cross-sectional view. The vacuum coating system 01 here is only schematically illustrated and only shows the system parts which are necessary for understanding the invention.

The vacuum coating system 01 has at least one process chamber 02, in which a vacuum can be produced in order to provide for the necessary process conditions for the coating of wafer elements 03. The wafer elements 03 are delivered through the vacuum coating system 01 into the transport direction 07 while passing through by means of a transport system having several transport devices 04, 05 and 06.

In order to be able to close the process chamber 02 in a pressure-tight manner, provision is made for two pivotably mounted paddle valves 08 and 09 by means of which the entry opening 10, respectively the exit opening 11, can be closed in a pressure-tight manner. The paddle valve closing path for opening and closing the paddle valve 09 is schematically illustrated in FIG. 1. In this embodiment, the paddle valves 08 and 09 need to be pivoted upwardly by approximately 90° for opening the entry opening 10 or the exit opening 11. For closing the two openings 10 and 11, the paddle valves 08 and 09 are pivoted downwardly and are pressed against the wall of the process chamber 02. During opening and closing of the paddle valves 08 and 09 in each case a circular segment having an opening angle of approximately 90° is covered.

In order to enable the opening and closing of the paddle valves 08 and 09, a distance is provided between the transport devices 04, 05 and 06. The transport of the wafer elements 03 over said gap between the transport devices 04, 05 and 06 is performed with the aid of two transfer transport devices 12 and 13. At the transfer transport devices 12 and 13, as in the case of the transport devices 04, 05 and 06, provision is in each case made for a conveyor belt 14 serving as a transport element. On said conveyor belt, the wafer elements 03 can be placed from above and can be delivered by driving the deflection rollers 15 into the transport direction 07. The distance between the transfer transport devices 12 and 13 on the one hand and the upstream or downstream transport devices 04, 05 and 06 on the other hand is just small enough to enable the wafer elements 03 to straddle said distance without any problems.

In order to be able to open or close the paddle valves 08 and 09, the transfer transport devices 12 and 13 can be pivoted between a downwardly pivoted idle position and an upwardly pivoted transfer position. The pivoting mechanism here can be mechanically coupled via the valve movement. The coupling with a separate actuator, for instance a motor or a pneumatic cylinder, is equally possible. If wafer elements are supposed to be delivered into the process chamber 02 or else are supposed to be removed from the process chamber 02, the paddle valves 08 and 09, in a first step, are pivoted upwardly, thereby opening the entry opening 10 or the exit opening 11. Subsequently, the transfer transport device 12, respectively 13, is pivoted upwardly and finally the wafer elements are moved by driving the conveyor belts 14 at the transport devices 04, 05 and 06, respectively at the transfer transport devices 12 and 13, into the transport direction 07. For closing the entry opening 10 or the exit opening 11, the transfer transport devices 12 and 13 are pivoted downwardly and subsequently, the paddle valves 08 and 09 are pivoted in front of the entry opening 10 or in front of the exit opening 11, respectively.

FIG. 2 shows the vacuum coating system 01 in a second embodiment of a transport system for transporting the wafer elements 03. In this embodiment of the transport system, an adjustable transfer transport device 16 is in each case integrated into a respective transport device 17 which is upstream and non-adjustable. Here, the transfer transport device 16 and the transport device 17 each use a common transport element 18, for instance a conveyor belt, which is clamped over two deflecting members 19 and 20, for instance deflection rollers. Here, the deflecting members 19 are adjustably mounted and can be linearly adjusted between an idle position and a transfer position into the transport direction 07, in order to thereby vary the effective length of the transfer transport device 16. FIG. 2 in this context shows the transfer transport device in the process chamber 02 in its idle position, which enables opening of the paddle valve 09, whereas the transfer transport device 16 at the entry opening 10 is in its transfer position, which enables transfer of the wafer elements 03 to the respective downstream transport device 17 without any problems.

The necessary length compensation of the transport element 18 when moving the deflecting member 19 between the idle position and the transfer position is realized by a clamping member 21. The deflection roller 22 provided in the clamping member 21, over which the transport element 18 is clamped, is spring-loaded and, depending on the position of the deflection roller 19, may be displaced upwardly or else downwardly in order to provide for the necessary length compensation.

For delivering of the wafer elements 03 into and out of the process chamber 03, the paddle valves 08 and 09 are pivoted upwardly and the deflection rollers are subsequently moved forward until only a small distance remains between the transfer transport devices 16, which are arranged one behind the other, and the downstream transport devices 17.

Subsequently, driving of the transport elements 18 provides for the necessary transport movement of the wafer elements 03 through the entry opening 10, respectively the exit opening 11. For closing the process chamber 02, the deflection rollers 19 are retracted, and the paddle valves 08 and 09 are then pivoted in front of the entry opening 10, respectively the exit opening 11.

1. A vacuum coating system comprising:
at least one process chamber that can be evacuated and having at least one entry opening and at least one exit opening, wherein wafer elements, which are coated in the process chamber while passing therethrough, can be fed into and removed from the process chamber through the entry opening and the exit opening and wherein;
a paddle valve, which can be adjusted between an open position and a pressure-tight closed position along a paddle valve closing path, is provided on each of the entry opening and on the exit opening; and
a transport system for the purpose of transporting the wafer elements, said transport system having at least three transport devices, wherein the first transport device is arranged upstream of the entry opening, the second transport device is arranged in the process chamber and the third transport device is arranged downstream of the exit opening, and wherein each transport device comprises at least one revolving transport element on which the wafer elements can be placed from above and can be delivered through the vacuum coating system by revolvingly driving the transport elements into the transport direction, said transport system having an adjustable transfer transport device at the entry opening and/or at the exit opening, said transfer transport device being adjustable between a transfer position and an idle position, wherein in the transfer position of the transfer transport device the wafer elements can be transferred from one transport device to the next transport device downstream in the delivery direction through the open entry opening or through the open exit opening, and wherein in the idle position of the transfer transport device the entry opening and/or the exit opening can be opened or closed by adjusting the associated paddle valve along the paddle valve closing path.

2. The vacuum coating system according to claim 1, in which at least one paddle valve is pivotably mounted and in response to a pivoting movement can be adjusted between the open position and the pressure-tight closed position along the paddle valve closing path.

3. The vacuum coating system according to claim 2, in which a sealing member is provided on a side of the paddle valve that faces towards the entry opening or towards the exit opening, said sealing member providing pressure-tight sealing of the sealing gap between the wall of the process chamber and the paddle valve when the paddle valve is in the closed position.

4. The vacuum coating system according to any of claim 1, in which the transfer transport device comprises at least one revolving transport element on which the wafer elements can be placed from above and can be delivered by revolvingly driving the transport element.

5. The vacuum coating system according to claim 1, in which the transport elements at the transport device and/or the transport elements at the transfer transport device are selected from a group consisting of a conveyor belt, conveyor cords, and conveyor wires.

6. The vacuum coating system according to claim 5, in which the transport elements are produced from a material selected from a group consisting of metallic material, a polymeric material, in particular woven polymer filaments, and a ceramic material, in particular woven ceramic filaments.

7. The vacuum coating system according to claim 1, in which the transport element of the transfer transport device is clamped over at least two deflecting members, in particular deflection rollers, wherein at least one deflecting member is pivotably mounted and can be pivoted between the transfer position and the idle position, the transport element in the transfer position extending into the transport direction and the transport element in the idle position being arranged outside of the paddle valve closing path.

8. The vacuum coating system according to claim 1, in which the transfer transport device is formed as an integral part of an upstream or downstream transport device, wherein the transfer transport device and the transport device use a common transport element for transporting the wafer elements, and wherein the part of the transport device which forms the transfer transport device can be adjusted between the transfer position and the idle position.

9. The vacuum coating system according to claim 8, in which the common transport element of the transfer transport device and of the upstream or downstream transport device in the transport direction is clamped over at least two deflecting members, in particular deflection rollers, wherein at least one deflecting member is adjustably mounted and can be adjusted between the transfer position and the idle position.

10. The vacuum coating system according to claim 9, in which the common transport element is guided over a mechanically adjustable clamping member to realize the length compensation when the transport element is adjusted between the transfer position and the idle position.

11. The vacuum coating system according to any of claim 1, in which at least one further system for processing the wafer elements while passing through is arranged upstream and/or downstream of the vacuum coating system, wherein the wafer elements are fed from the upstream system into the vacuum coating system by means of transport devices without intermediate storage, and/or the wafer elements are delivered from the vacuum coating system into the downstream system without intermediate storage.

12. A method for coating wafer elements in a vacuum coating system, comprising at least one process chamber that can be evacuated, and at least one entry opening and at least one exit opening, wherein a paddle valve, which can be adjusted between an open position and a pressure-tight closed position along a paddle valve closing path, is respectively provided on the entry opening and on the exit opening, and wherein for the purpose of transporting the wafer elements a transport system having at least three transport devices is provided, wherein the first transport device is arranged upstream of the entry opening, the second transport device is arranged in the process chamber and the third transport device is arranged downstream of the exit opening, and wherein each transport device comprises at least one revolving transport element on which the wafer elements can be placed from above and can be delivered through the vacuum coating system by revolvingly driving the transport elements into the transport direction said method comprising the following method steps of:
a) delivering the wafer elements by means of the first transport device;
b) moving the transfer transport device at the entry opening into the idle position and opening the paddle valve at the entry opening;
c) moving the transfer transport device at the entry opening into the transfer position, delivering the wafer elements through the entry opening and transferring the wafer elements onto the second transport device;
d) moving the transfer transport device at the entry opening into the idle position and closing the paddle valve at the entry opening;
e) coating the wafer elements in the process chamber;
f) moving the transfer transport device at the exit opening into the idle position and opening the paddle valve at the exit opening;
g) moving the transfer transport device at the exit opening into the transfer position, delivering the wafer elements through the exit opening and transferring the wafer elements onto the third transport device; and
h) moving the transfer transport device at the exit opening into the idle position and closing the paddle valve at the exit opening.

13. The method according to claim 12, in which the paddle valve at the entry opening and/or the paddle valve at the exit opening for the purpose of opening is pivoted into the open position and for the purpose of closing is pivoted into the closed position.

14. The method according to claim 12, in which the wafer elements are processed in a system upstream of the vacuum coating system and are delivered from the upstream system into the vacuum coating system without intermediate storage.

15. The method according to claim 12, in which the wafer elements are processed in a system downstream of the vacuum coating system and are delivered from the vacuum coating system into the downstream system without intermediate storage.
